(19) United States
(12) Patent Application Publication
(10) Pub. No.: US 2025/0081990 A1
(43) Pub. Date: Mar. 13, 2025

(54) EDIBLE PET CHEW PRODUCT AND RELATED METHOD OF MANUFACTURE

(71) Applicant: Mario Osmar Guardia, Santa Cruz de la Sierra (BO)

(72) Inventor: Mario Osmar Guardia, Santa Cruz de la Sierra (BO)

(73) Assignee: BRAZILIAN PET LLC, Longwood, FL (US)

(21) Appl. No.: 18/243,147

(22) Filed: Sep. 7, 2023

(51) Int. Cl. A23K 10/26; A23K 40/00; A23K 50/42; C14B 1/02; C14B 1/58

(52) U.S. Cl. CPC A23K 10/26; A23K 40/00; A23K 50/42; C14B 1/02; C14B 1/58

(57) ABSTRACT

A method provides an edible pet chew product having an elongated stick of bovine collagen that is wrapped in a bovine tripe sheet having a moisture ratio of less than 10 percent before being cured.

### TECHNICAL FIELD

The present invention relates generally to pet products, and more particularly to a system and method for producing an edible pet chew product.

### BACKGROUND

Chewable products for animals such as dogs are widely known and manufactured for the purpose of providing a chewable device that can be consumed by the animal. Many such chewable products are made from a single ingredient such as hardened rawhide, whereas other such products are made from a combination of materials such as rawhide and plastic or other man-made synthetic materials. These chewable products are purposely made of hardened material to allow the animal to chew for an extended period of time before breaking down. Although useful for allowing the animal to chew for long periods of time, there is essentially no nutritional value in such products.

Conversely, chewable products made of animal-based materials are intended for consumption by the animal, and to provide nutritional value. Such products are typically made from a single ingredient such as high-protein beef muscle from the pizzle of a bull. These products are designed to be chewed by the animal until small enough pieces are formed that may be swallowed. Unfortunately, these products typically lack the hardness of rawhide-type products and have a tendency to quickly break down. Indeed, it is not uncommon for these types of chews to be completely consumed by the animal within minutes of receiving them.

Accordingly, it would be beneficial to provide an edible pet chew product having a roughened outer shell that can withstand substantive chewing from an animal, and ultimately provide nutritional value when consumed, so as to overcome the drawbacks noted above.

### SUMMARY OF THE INVENTION

The present invention is directed to an edible pet chew product and a method of manufacturing the same. In one embodiment, the edible pet chew product includes an elongated stick of bovine collagen; and a bovine tripe sheet having a moisture ratio of less than 10 percent. In the finished product, the bovine tripe sheet is wrapped around the elongated collagen stick to provide chew palatability.

In another embodiment, a method of creating the edible pet chew product includes the steps of removing hair from bovine leather, fleshing the bovine leather, separating collagen from the bovine leather, cleaning the separated collagen and forming elongated collagen strips, receiving and cleaning bovine tripe, before drying the bovine tripe, forming tripe sheets, and wrapping the tripe sheets around the collagen strips before curing the same.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a process flowchart for preparing an edible pet chew product according to a current embodiment.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

As described throughout this document, the term “about” “approximately” “substantially” and “generally” shall be used interchangeably to describe a feature, shape or measurement of a component within a tolerance such as, for example, manufacturing tolerances, measurement tolerances or the like.

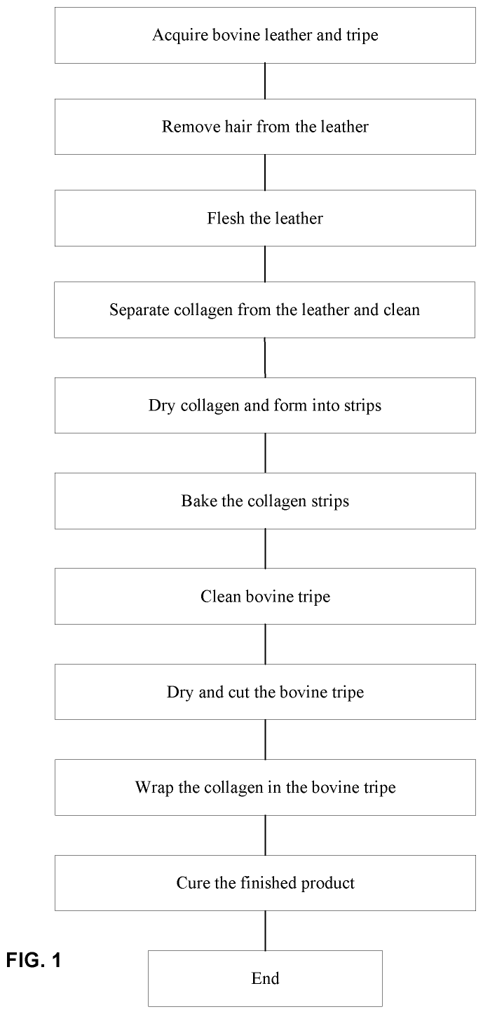

One embodiment of a method for creating an edible pet chew product can include the following steps, which are generally illustrated in the flowchart of FIG. 1. Other features of the current embodiments will become apparent in the course of the following descriptions, which are given for illustration of the current embodiments, and are not intended to be limiting thereof.

Step 1. Acquiring product materials. In the preferred embodiment, bovine leather and tripe is received in natural form from a slaughterhouse.

Step 2. Removing hair from the leather. In the preferred embodiment, a rotatable drum cattle dehairing machine can be utilized to strip and remove all hair and other debris from the skin of the received leather. Of course, any number of other types of machines, processes or methods can be utilized. At the conclusion of this step, the leather is malleable and retains a high concentration of fat.

Step 3. Fleshing the leather. Next, the leather can be fleshed so as to remove the subcutaneous connective tissue, fat and meat residue. In the preferred embodiment, a fleshing machine having a series of rotating scraping rolls can be utilized, however any number of other types of machines, processes or methods can be utilized. At the conclusion of this step, the leather remains malleable, with virtually no fat or meat residue.

Step 4. Collagen separation. Next, the leather can be treated to break the covalent intermolecular crosslinks between collagen molecules in the dermis of the leather. In the preferred embodiment, this process can be accomplished mechanically (rather that utilizing boiling water, acids or alkaline treatments). Specifically, the process can be performed by hand or via a machine utilizing a plurality of blades to slice and divide the leather horizontally, thus separating the collagen layer from the rest of the bovine skin. Of course, any number of other techniques may also be utilized at this step.

Step 5. Cleaning the collagen. At this step, the extracted collagen can be washed and rinsed to remove any contaminants leftover from the extraction process. At this time, amino acids such as lysine and valine can be added. This will typically be in the form of bovine hemoglobin which acts as a source of hemic iron to aid in making the resulting product more digestive to the animal. At the conclusion of this step, the cleaned collagen has an extremely high moisture ratio of about 35% (total weight) and is malleable.

Step 6. Drying the collagen. At this step, heat is applied to the collagen from step 5until the moisture of the resulting product is reduced to about 20. At the conclusion of this step, the dried collagen is semi-malleable.

Step 7. Forming the collagen strips. At this step, the semi-malleable collagen from step 6 are cut into strips of approximately 10 centimeters in width and are rolled to remove any sharp corners or edges from the product.

Step 8. Cleaning the bovine tripe. In the preferred embodiment, the bovine tripe received at step 1 can receive an initial rinse to remove any debris or contaminants, and then can be immersed in hemoglobin for 10 hours. The hemoglobin immersion functions to increase the resulting flavor of the finished product and add color to the tripe. Of course, any number of other methods for cleaning and introducing flavor and color to the tripe are also contemplated. At the conclusion of this step, the tripe will be semi malleable and contain a moisture ratio of about 20%-30%.

Step 9. Drying and cutting the bovine tripe. Next, the tripe from step 8 can be air dried or heat dried until the moisture ratio is less than 10%. At this time, the tripe can be cut into flat sheets. At the conclusion of this step, the tripe will be semi-malleable.

Step 10. Combining the collagen and tripe. At this step, the collagen strips from step 7 can be wrapped in one or more layers of the dried bovine tripe sheets from step 9. In the preferred embodiment, the bovine tripe will be rolled about the collagen strip such that the ends of the collagen strips will be visible; however, other embodiments are also contemplated.

Step 11. Curing the final product. At this step, the assembled product will be cured to harden and secure the components together so that they will not separate when being chewed by the animal. In the preferred embodiment, the product can be placed into a commercial oven where it is baked for 48 hours at a temperature range of between 50 and 90 degrees Celsius. Of course, other methods for curing the final product is also contemplated

Through the steps outlined above, the final product will include a roughened outer shell which will withstand the rigors of vigorous chewing for a period of time equivalent to rawhide. As the animal continues to chew and the tripe is consumed, they will encounter the collagen inside. The collagen will resist the rigors of chewing in an amount equivalent to non-coated edible chew products, thus inclusion of the tripe layer slows the overall consumption of the resulting product. In this regard, the resulting product retains the long-term chew resistance of traditional rawhide treats while providing the nutritional elements of bovine collagen.

Although described above as utilizing particular machinery and/or steps in a particular order, this is for illustrative purposes only. To this end, those of skill in the art will recognize that any number of different types of machinery can be utilized to create the edible pet chew product. Additionally, the above noted steps may also be performed in an order different than that described above. As such, the invention is not to be construed as limiting.

Finally, those with skill in the art will realize that any number of additives can also be provided throughout the process to increase the flavor profile of the end product. Several examples can include meat (e.g., beef, chicken, lamb) concentrate or artificial concentrate pertaining to the same, along with various other vegetable, roots, sugars, spices, proteins, carbohydrates, lipids, vitamins minerals, and fiber, for example, in order to augment the taste, consistency and/or health benefits of the final product. One or more of these items can be introduced at any step of the manufacturing process, in accordance with manufacturing techniques.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of preparing an edible pet chew product, said method comprising:
providing bovine leather;
removing a plurality of hairs from the bovine leather;
fleshing the bovine leather;
separating collagen from the bovine leather;
cleaning the separated collagen;
forming the separated collagen into a plurality of elongated collagen strips;
providing bovine tripe;
cleaning the bovine tripe;
drying the bovine tripe;
forming the dried bovine tripe into a plurality of bovine tripe sheets;
wrapping one of the plurality of bovine tripe sheets around on of the collagen strips to form an assembled product; and
curing the assembled product.

2. The method of claim 1, wherein the finished product is produced utilizing no artificial ingredients.

3. The method of claim 1, wherein said fleshing includes removing any subcutaneous connective tissue from the bovine leather.

4. The method of claim 1, wherein said fleshing includes removing any fat from the bovine leather.

5. The method of claim 1, wherein said fleshing includes removing any meat from the bovine leather.

6. The method of claim 1, wherein said fleshing includes removing any subcutaneous connective tissue from the bovine leather, removing any fat from the bovine leather and removing any meat from the bovine leather.

7. The method of claim 1, wherein the cleaned separated collagen has a moisture ratio of about 35 percent.

8. The method of claim 7, further comprising:
drying the cleaned separated collagen to reduce the moisture ratio to about 20 percent.

9. The method of claim 8, wherein said drying the cleaned separated collagen is performed immediately after said cleaning the separated collagen.

10. The method of claim 1, further comprising:
baking the formed collagen strips.

11. The method of claim 10, wherein the baked collagen strips have a moisture ratio of about 10 percent.

12. An edible pet chew product produced by the method of claim 1, the product consisting of:
an elongated collagen stick of bovine collagen; and
a bovine tripe sheet having a moisture ratio of less than 10 percent.
wherein the bovine tripe sheet is wrapped around the elongated collagen stick.
